(19) United States
(12) Patent Application Publication
(10) Pub. No.: US 2003/0165238 A1
(43) Pub. Date: Sep. 4, 2003

(54) A METHOD FOR ENCODING LONG MESSAGES FOR ELECTRONIC SIGNATURE SCHEMES BASED ON RSA

(76) Inventors: David Naccache, Paris (FR); Jean-Sebastien Coron, Paris (FR)

Correspondence Address: BURNS DOANE SWECKER & MATHIS L L P, POST OFFICE BOX 1404, ALEXANDRIA, VA, 22313-1404, US

(21) Appl. No.: 10/130,937

(22) PCT Filed: Sep. 26, 2001
(86) PCT No.: PCT/FR01/02983

(30) Foreign Application Priority Data
Sep. 28, 2000 (FR) 00/12351

(51) Int. Cl. H04K 1/00

(52) U.S. Cl. 380/30

(57) ABSTRACT

The RSA enciphering algorithm is the most widely used public key enciphering algorithm.

The invention consists in defining a novel method of message encoding allowing arbitrarily long message signatures and without using a hash function. The invention can be used easily in an electronic component of the smart card type.

The present invention relates to a method for encoding long messages for electronic signature schemes based on RSA.

In the conventional model of secret key cryptography, two persons wishing to communicate by means of a non-secure channel must first agree on a secret enciphering key K. The enciphering function and the deciphering function use the same key K. The drawback of the secret key enciphering system is that the said system requires the prior communication of the key K between the two persons by means of a secure channel, before any enciphered message is sent through the non-secure channel. In practice, it is generally difficult to find a perfectly secure communication channel, especially if the distance separating the two persons is great. Secure channel means a channel for which it is impossible to know or modify the information passing over the said channel. Such a secure channel can be implemented by a cable connecting two terminals possessed by the said two persons.

The concept of public key cryptography was invented by Whitfield Diffie and Martin Hellman in 1976. Public key cryptography resolves the problem of the distribution of the keys through a non-secure channel. The principle of public key cryptography consists in using a pair of keys, a public enciphering key and a private deciphering key. It must be unfeasible from the computing point of view to find the private deciphering key from the public enciphering key. A person A wishing to communicate information to a person B uses the public enciphering key of the person B. Only the person B possesses the private key associated with his public key. Only the person B is therefore capable of deciphering the message which is sent to him.

Another advantage of public key cryptography over secret key cryptography is that public key cryptography allows authentication by the use of an electronic signature.

The first embodiment of a public key enciphering scheme was developed in 1977 by Rivest, Shamir and Adleman, who invented the RSA enciphering system. RSA security is based on the difficulty of factorising a large number which is the product of two prime numbers. Since then, many public key enciphering systems have been proposed, whose security is based on various computing problems (this list is not exhaustive):

Merkle-Hellman “knapsack”: This enciphering system is based on the difficulty of the problem of the sum of subsets;

McEliece: This enciphering system is based on the theory of algebraic codes. It is based on the problem of the decoding of linear codes;

ElGamal: This enciphering system is based on the difficulty of the discrete logarithm in a finite field;

Elliptic curves: The elliptic curve enciphering system constitutes a modification of existing cryptographic systems in order to apply them to the field of elliptic curves. The advantage of elliptic curve enciphering systems is that they require a smaller size of key than for the other enciphering systems.

The RSA enciphering system is the most widely used public key enciphering system. It can be used as an enciphering method or as a signature method. The RSA enciphering system is used in smart cards, for certain applications thereof. The possible applications of RSA to a smart card are access to data banks, banking applications, remote payment applications such as for example pay television, petrol dispensing or the payment of motorway tolls.

The principle of the RSA enciphering system is as follows. It can be divided into three distinct parts, namely:

1) The generation of the pair of RSA keys;

2) The enciphering of a message in clear into an enciphered message, and

3) The deciphering of an enciphered message into a message in clear.

The first part is the generation of the RSA key. Each user creates an RSA public key and a corresponding private key, in accordance with the following method in 5 steps:

1) Generating two distinct prime numbers p and q of the same size;

2) Calculating n=pq and φ=(p−1)(q−1)

3) Randomly selecting an integer e, 1<e<φ, such that pgcd (e, φ)=1;

4) Calculating the unique integer d, 1<d<φ, such that e*d=1 mod φ;

5) The public key is (n,e); the private key is d or (d,p,q).

The integers e and d are called respectively the enciphering exponent and the deciphering exponent. The integer n is called the modulus.

The second part consists in enciphering a message in clear denoted m by means of an algorithm with 1<m<n into an enciphered message denoted c, which is as follows:

Calculating c=m\hat{ }e mod n.

The third part consists in deciphering an enciphered message using the private deciphering exponent d by means of an algorithm. The algorithm for deciphering an enciphered message denoted c with 1<c<n into a message in clear denoted m is as follows:

Calculate m=c\hat{ }d mod n.

The RSA system can also be used for generating electronic signatures. The principle of an electronic signature scheme based on the RSA system can generally be defined in three parts:

The first part being the generation of the RSA key, using the method described in the first part of the RSA system described previously;

The second part being the generation of the signature. The method consists in taking as an input the message M to be signed, applying to it an encoding using a function μ in order to obtain the character string μ(M), and applying the deciphering method of the third part of the RSA system described above. Thus only the person possessing the private key can generate the signature;

The third part being the verification of the signature. The method consists in taking as an input the message M to be signed and the signature s to be verified, applying an encoding to the message M using a function μ in order to obtain the character string μ(M), applying to the signature s the enciphering method described in the second part of the RSA system, and verifying that the result obtained is equal to μ(M). In this case, the signature s of the message M is valid, and in the contrary case it is false.

There are many encoding methods using different functions μ. One example of an encoding method is the method described in the standard “ISO/IEC 9796-2, Information Technology—Security techniques—Digital signature scheme giving message recovery, Part 2: Mechanisms using a hash-function, 1997”. Another example of the encoding method is the encoding method described in the standard “RSA Laboratories, PKCS#1: RSA cryptography specifications, version 2.0, September 1998”. These two encoding methods make it possible to sign messages of arbitrarily long size.

The drawback of the two encoding methods cited above is that they require the use of a hash function. A hash function is a function taking as an input a message of arbitrarily long size and returning as an output a character string of fixed size. The drawback is that it is not possible in the current state of knowledge to strictly prove the security of such hash functions. It is therefore not possible to strictly prove the security of the two encoding methods cited above.

The method of the invention consists of a method for implementing a coding function taking as an input arbitrarily long messages, using an encoding function taking as an input messages of limited size. The method of the invention uses exclusively operations of the arithmetic type, for which it is possible to strictly prove the security.

The invention comprises 2 distinct methods implementing an encoding function, the said encoding function taking as an input arbitrarily long messages, using an encoding function taking as an input messages of limited size.

The first method of the invention uses a unique RSA modulus N as defined in the first part of the RSA system described above. The first method of the invention uses an encoding function μ taking as an input a message of limited size with k+1 bits, k being an integer parameter, and returning as an output a character string of size exactly k bits. The first method of the invention takes as an input an integer parameter a between 0 and k−1. the first method of the invention consists in defining a new encoding function μ′ taking as an input a message of size no more than (2\hat{ }a)*(k−a) bits and returning as an output a message of size k bits.

By means of a repeated application of the first method of the invention, it is thus possible to construct an encoding function taking as an input messages of arbitrarily long size. The first method of the invention consists of the following 4 steps:

1) Separating the message into blocks of size k−a bits. The message is denoted m=m[1]||m[2]|| . . . ||m[r] where r is the number of blocks.

2) Initialising to 1 an integer variable b.

3) For i ranging from 1 to r, calculating the result of the function μ applied to the string of bits formed by the concatenation of the bit 0, of the counter i represented by a string of a bits and of the block m[i], and multiplying the said result by the variable b, the result of the multiplication being stored in the variable b, the said multiplication being implemented modulo N;

4) Applying the function μ to the string of bits formed by the concatenation of the bit 1 and of the variable b, and returning the result as an output.

The second method of the invention consists in using two distinct moduli N1 and N2, the said moduli being as defined in the first part of the RSA system described above. The second method of the invention uses two encoding functions μ1 and μ2 taking as an input a message of size k1 and k2, respectively, and returning as an output a message of size k1′ and k2′ respectively. The second method of the invention takes as an input an integer parameter a between 0 and k−1. The second method of the invention consists in defining a new encoding function μ′ taking as an input a message of size no more than (2\hat{ }a)*(k1−a) bits and returning as an output a message of size k2′ bits. Through a repeated application of the second method of the invention, it is thus possible to construct an encoding function taking as an input messages of arbitrarily long size. The second method of the invention consists of the following 4 steps:

1) Separating the message into blocks of size k1−a bits. The message is denoted m=m[1]||m[2]|| . . . ||m[r] where r equals the number of the blocks.

2) Initialising to 1 an integer variable b.

3) For i ranging from 1 to r, calculating the resulting of the function μ1 applied to the string of bits formed by the concatenation of the counter i represented by a string of a bits and of the block m[i], and multiplying the said result by the variable b, the result of the multiplication being stored in the variable b, the said multiplication being implemented modulo N1.

4) Applying the function μ2 to the string of bits formed by the variable b, and returning the result as an output.

By the above method there is defined an encoding function μ′ taking as an input a message of size (2\hat{ }a)*(k1−a) and returning as an output a message of size k2′ bits. When the previously described signature generation and signature verification methods based on RSA are applied, the calculations take place using the RSA modulus N2.

The advantage of the second method of the invention over the first method of the invention is that it offers more flexibility in the choice of the encoding function μ. This is because, in the first method, the constraint was that μ is an encoding function from k+1 bits to k bits. This constraint does not exist in the second method of the invention.

1. A method using an RSA modulus N, the said method using an encoding function μ taking as an input a message of size limited to k+1 bits, k being an integer parameter, and returning as an output a character string of size exactly k bits, the said method taking as an input an integer parameter a between 0 and k−1, the said method consisting in defining a new encoding function μ′ taking as an input a message of size no more than (2\hat{ }a)*(k−a) bits and returning as an output a message of size k bits, said method characterised in that it includes the following 4 steps:
1) Separating the message into blocks of size k−a bits, the message being denoted m=m[1]||m[2]|| . . . ||m[r] where r is the number of blocks.
2) Initialising to 1 an integer variable b.
3) For i ranging from 1 to r, calculating the result of the function μ applied to the string of bits formed by the concatenation of the bit 0, of the counter i represented by a string of a bits and of the block m[i], and multiplying the said result by the variable b, the result of the multiplication being stored in the variable b, the said multiplication being implemented modulo N;
4) Applying the function μ to the string of bits formed by the concatenation of the bit 1 and of the variable b, and returning the result as an output.

2. An encoding method according to claim 1, taking as an input a message of arbitrarily long size, characterised in that the method of claim 1 is repeated several times.

3. A method using two distinct RSA moduli N1 and N2, the said method using two encoding functions μ1 and μ2 taking as an input a message of size k1 and k2 respectively and returning as an output a message of size k1′ and k2′ respectively, the said method taking as an input an integer parameter a between 0 and k−1, the said method consisting in defining a new encoding function μ′ taking as an input a message of size no more than 2\hat{ }a*(k1−a) bits and returning as an output a message of size k2′ bits, the said method being characterised in that it comprises the following 4 steps:
1) Separating the message into blocks of size k1−a bits, the message being denoted m=m[1]||m[2]|| . . . ||m[r] where r is the number of blocks.
2) Initialising to 1 an integer variable b.
3) For i ranging from 1 to r, calculating the resulting of the function μ1 applied to the string of bits formed by the concatenation of the counter i represented by a string of a bits and of the block m[i], and multiplying the said result by the variable b, the result of the multiplication being stored in the variable b, the said multiplication being implemented modulo N1.
4) Applying the function μ2 to the string of bits formed by the variable b, and returning the result as an output.

4. An encoding method according to claim 3, characterised in that the generation and verification of the signature are performed using the RSA modulus N2 as defined in claim 3.

5. A method according to any one of the preceding claims, characterised in that it is used in the context of a portable object of the smart card type.
